(19) United States
(12) Patent Application Publication
(10) Pub. No.: US 2022/0356425 A1
(43) Pub. Date: Nov. 10, 2022

(54) METHOD OF REDUCING ALCOHOL CONTENT IN A SPIRIT USING A NON-WATER LIQUID, AND A METHOD OF PRODUCING A CUT SPIRIT

(71) Applicant: James Joseph Sanctified Spirits, LLC, Westlake, TX (US)

(72) Inventor: Joseph Giildenzopf, Westlake, TX (US)

(21) Appl. No.: 17/737,688

(22) Filed: May 5, 2022

Related U.S. Application Data
(60) Provisional application No. 63/184,298, filed on May 5, 2021.

(51) Int. Cl. C12H 3/00; C12G 3/07

(52) U.S. Cl. CPC C12H 3/00; C12G 3/07

(57) ABSTRACT

The disclosure provides a process to create unique spirits by using another liquid besides water to cut or dilute a distilled spirit. The liquid used for cutting, referred to herein as a cutting liquid, can be used to obtain a desired proof. A distilled spirit that has been cut with a cutting liquid is referred to herein as a cut spirit. In one example, a method of manufacturing an alcoholic beverage includes: (1) obtaining a distilled spirit, (2) creating a cut spirit by reducing alcohol content of the distilled spirit using one or more cutting liquids instead of water, (3) placing the cut spirit in multiple bottles, and (4) sealing the multiple bottles.

### CROSS-REFERENCE TO RELATED APPLICATION

This application claims the benefit of U.S. Provisional Application Ser. No. 63/184,298, filed by Joseph Giildenzopf on May 5, 2021, entitled “A METHOD OF REDUCING ALCOHOL CONTENT IN A SPIRIT USING A NON-WATER LIQUID, AND A METHOD OF PRODUCING A CUT SPIRIT,” commonly assigned with this application and incorporated herein by reference in its entirety.

### TECHNICAL FIELD

This application is directed, in general, to producing spirits and, more specifically, to the process of cutting a spirit

### BACKGROUND

A distilled spirit, also referred to as a distilled beverage, liquor, hard liquor or hard alcohol, is an alcoholic beverage produced by distillation of fermented grains, fruit, or vegetables. Some distilled spirits, such as whiskey, bourbon, scotch, and rum, are aged after distillation. Aging is a process of storing the distilled spirits in wood barrels for an amount of time to add distinct flavors and remove harsh flavors from the raw alcohol. The wood barrels are typically constructed of toasted wood that interacts with the distilled spirit to contribute organic compounds and transforms acids into esters to give spirits their unique flavor.

The distilled spirit obtains distinct flavors from the different types of wood that are used for the barrels. In addition to distinct flavors, aging also adds color to the clear distilled spirits. The amount of time and the type of wood barrels can be specified for some distilled spirits. For example, all Scotch whisky must be aged in oak barrels for at least three years.

Once a distilled spirit is aged, it is removed from the wood barrel and is bottled for distribution or later consumption. In contrast to wines, distilled spirits do not improve with age once removed from the wood barrels and placed in bottles. Instead, the maturation of the distilled spirit ends when removed from the wood barrels and the taste of the unopened whiskey, rum, etc. remains the same or essentially the same while bottled and waiting on the shelf.

### SUMMARY

In one aspect, a method of producing a cut spirit is disclosed. In one example, the method of producing a cut spirit includes: (1) obtaining a distilled spirit, and (2) reducing alcohol content of the distilled spirit using a cutting liquid to create a cut spirit.

In another aspect, a method of manufacturing an alcoholic beverage is disclosed. In one example, the method includes: (1) obtaining a distilled spirit, (2) creating a cut spirit by reducing alcohol content of the distilled spirit using one or more cutting liquids, (3) placing the cut spirit in multiple bottles, and (4) sealing the multiple bottles.

### BRIEF DESCRIPTION

Reference is now made to the following descriptions taken in conjunction with the accompanying drawings, in which:

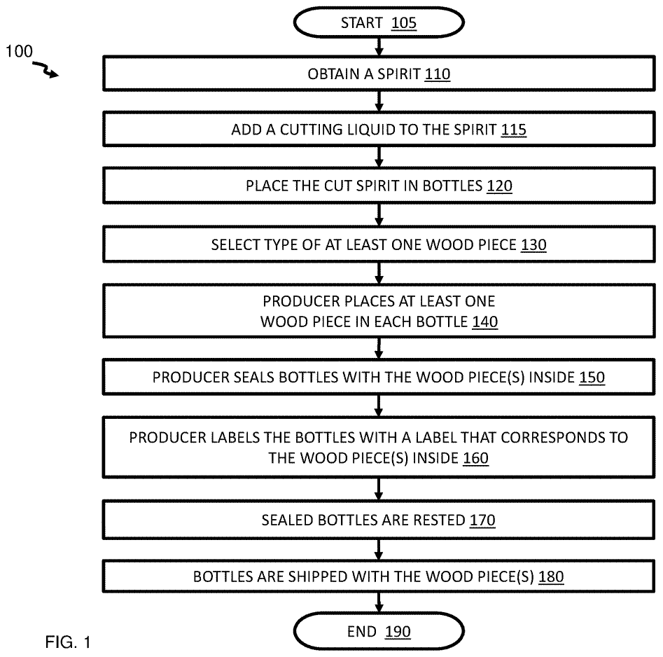

FIG. 1 illustrates a flow diagram of an example of a method of producing an enhanced cut spirit carried out according to the principles of the disclosure;

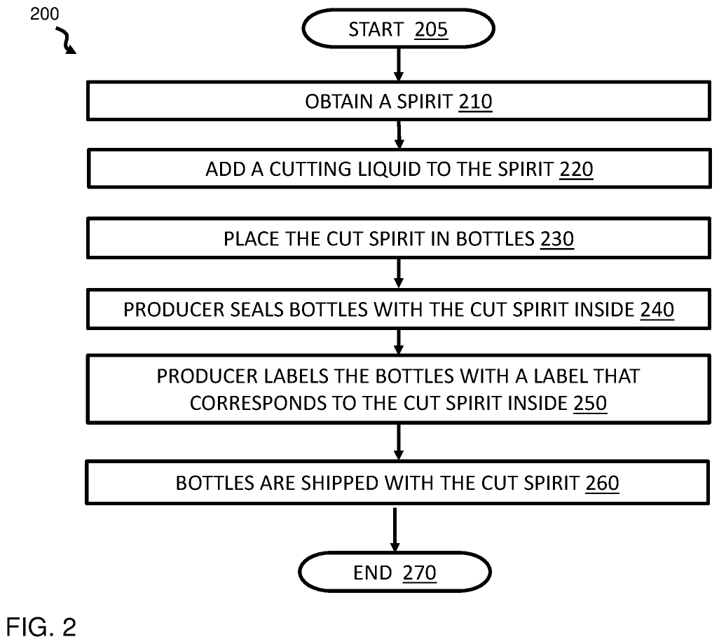

FIG. 2 illustrates a flow diagram of another example of a method of producing a cut spirit produced according to the principles of the disclosure;

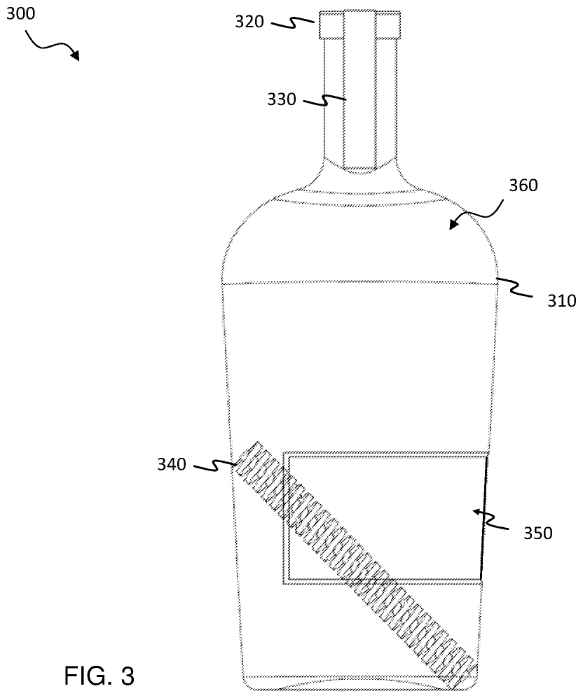

FIG. 3 illustrates an embodiment of a bottle of an enhanced cut spirit produced according to the principles of the disclosure;

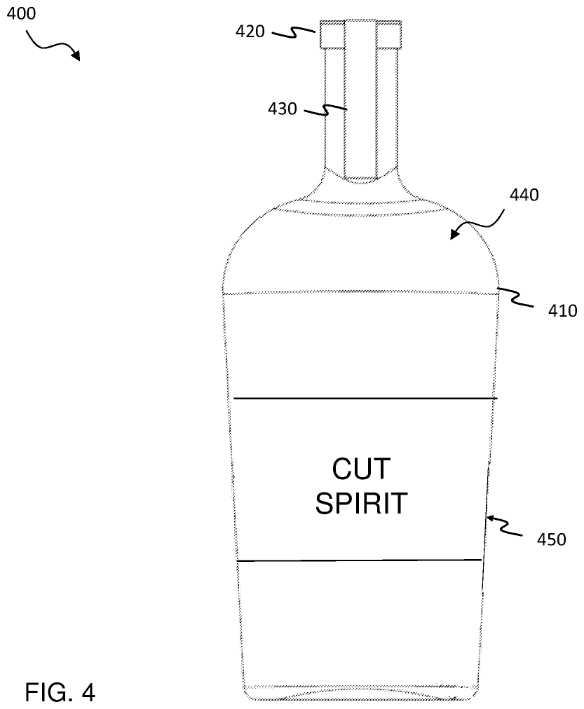

FIG. 4 illustrates an example of another bottle of a cut spirit produced according to the principles of the disclosure; and

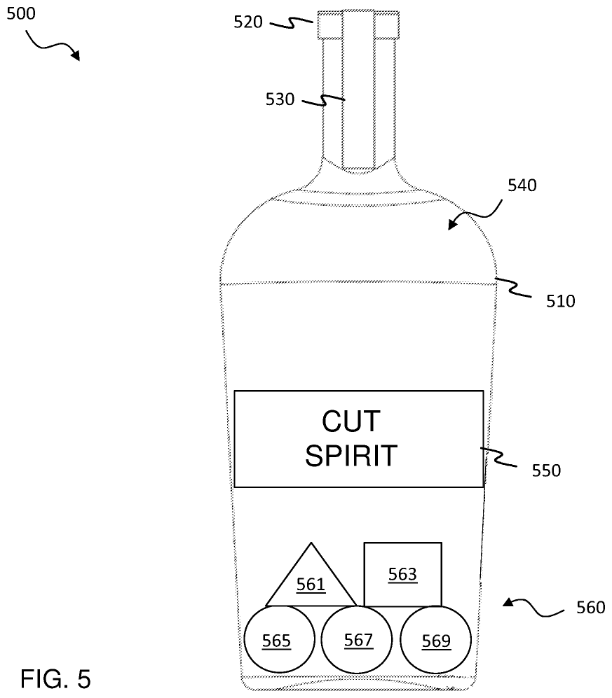

FIG. 5 illustrates an example of a bottle of a cut spirit having multiple wood pieces for enhancing according to the principles of the disclosure.

### DETAILED DESCRIPTION

Before being bottled, a distilled spirit is typically “cut” to lower the alcoholic content. For example, when a distilled spirit is obtained from the distillation process and/or an aging barrel, the alcohol content is typically high compared to the final product. The distilled spirit is then cut with water to lower the alcohol content to a particular amount, i.e., a desired amount. The amount of water used relates to the desired amount of alcohol content. Once the distilled spirit is reduced to the desired alcohol (ethanol) content, the distilled spirit can be bottled for distribution or later consumption.

The alcohol content in the distilled spirit can be specified in several ways, including alcohol by volume (ABV), alcohol by weight (ABW), or proof. A hydrometer can be used to estimate the volume of alcohol in a distilled spirit by measuring the specific gravity (SG) and estimating the volume of alcohol. Various empirical formulas are used in the industry to estimate or determine the alcohol content of a spirit, such as a distilled spirit, and the amount of water needed to obtain a desired alcohol content from the distilled spirit. For example, the formula FPx+WPy=DP (x+Y) can be used wherein FP is the full proof or distilled proof of the distilled spirit, WP is the proof of water, DP is the desired proof of the final product, x is the volume of the distilled spirit at full proof, and y is the volume of the water used for cutting.

In the United States, the proof is twice the ABV. For example, full proof whiskey can be between approximately 115-125 proof, which is 57.5% to 62.5% ABV. To obtain a lesser proof of 90, which is an ABV of 45%, the full proof whiskey is cut with an amount of water, which can be determined using the above formula or another similar formula. Another desired proof besides the example 90 proof can be obtained with more or less water.

Whisky and some other distilled spirits include water before being cut. In other words, some spirits are distilled at less than 100% ABV by law. For example, by U.S. law whiskey is distilled no greater than 80% ABV and then additional water is added to obtain a product before bottling that has a desired proof. The water used for cutting is the liquid state of H₂O and can be, for example, distilled water or reverse osmosis (RO) water.

An additional processing step is sometimes used to add additional flavor to distilled spirits, such as aged distilled spirits, before being bottled. This step, referred to as finishing, is a technique whereby aged spirits are placed in a secondary barrel or cask (or even more than one) for further maturation. The secondary cask or casks may have been used previously to age another spirit, like rum, brandy, wine, or beer. A finished spirit is sometimes referred to as double-matured since the spirit is matured in a first cask (aging) and then matured in another cask (a second cask for finishing) of a different origin.

By placing the aged spirit in one or more secondary casks the spirit takes on new, more nuanced flavors from the wood and other elements that are inherent to the secondary cask. This “finishes” the spirit and makes it unique (sanctified). Unfortunately, finishing requires more time in addition to the time used for aging. As such, the cost and time for finishing can outweigh the benefit of a finished spirit. The time required for aging and then finishing can have a chilling effect on the development and delivery of new alcoholic products to the market.

The disclosure advantageously introduces a process to create unique spirits that does not require additional time for aging and/or finishing. Instead, a process is disclosed that utilizes another liquid besides water to cut or dilute a distilled spirit. The liquid used for cutting, referred to herein as a cutting liquid, can be used to obtain a desired proof. A distilled spirit that has been cut with a cutting liquid is referred to herein as a cut spirit. The cut spirit can be ready for bottling and may have already been aged and/or finished. The cut spirit may also be aged and/or finished after cutting and before bottling. Additionally, the cut spirit can be enhanced with in-bottle finishing.

The cutting liquid can be a non-alcoholic liquid, including beverages such as coffee or juices (e.g., fruit juice or vegetable juice), which is utilized to lower the alcohol content of a distilled spirit. The cutting liquid can also be spirit, such as wine, that has a lower alcohol content than the spirit to cut. The cutting liquid can include water but is different than water, a non-water liquid, such as a liquid having a density and/or specific gravity that is different than water. For example, different whiskey types, such as bourbon, rye, single malt, etc., or other distilled spirits can be blended with different types of coffees, such as Ethiopian, Sumatran, Colombian, etc. Once the whiskey is cut (blended) with coffee in this example, the proof is not only lowered but the resulting product is a new spirit, e.g., is no longer whiskey. Instead a whiskey—coffee blend is obtained. As such, the cut spirit may longer be defined as the type of spirit as the distilled spirit but as a different type of spirit. A combination of different cutting liquids can be used with a distilled spirit to obtain a cut spirit. For example, different types of coffee can be utilized or a coffee and one or more other types of liquid can be used for cutting.

In addition to using a cutting liquid, at least one wood piece can be used for further maturation or enhancing of the cut spirit after being placed in the bottle. For example, a wood piece can be used for finishing of an aged cut spirit that is in the bottle. Thus, instead of in-cask finishing, in-bottle finishing can also be utilized with one or more cutting liquids. At least one wood piece can be placed in each of the bottles during manufacturing before the bottle is capped and sealed for commercial sale and distribution. Sealing can be used herein to refer to capping and sealing a cut spirit in a bottle (such as a glass bottle) for commercial sale. Sealing can be performed according to industry standards and via a conventional method including, but not limited to, cork type closures, capsules (including spinning and shrinking), and screw-on caps. Once sealed, the seal is broken and the cap or lid is removed by the purchaser/consumer of the bottled cut spirit.

The wood piece can be produced to increase the interaction of the wood with the cut spirit in the bottle. As such, the amount of time for finishing of an aged distilled spirit compared to in-cask finishing can be reduced. Since part of the manufacturing process of the cut spirit can include using at least one wood piece, consistency of the wood pieces that are employed for finishing is needed. Accordingly, the wood pieces are produced according to certain parameters to produce a consistent finish across multiple bottles; including bottles having different volumes. One or more wood pieces can also be rested for an amount of time in one or more liquids or non-liquids before being placed in a bottle.

Different types of a wood piece or pieces can be used. The wood pieces can be cut to provide a high ratio of wood surface area to the spirit in a bottle. The wood pieces can be cut to provide an orientation of the wood grain to wood surface for an optimal wood-to-spirit in-bottle interaction. Accordingly, the surface area and grain orientation of the wood piece can be designed to reduce finishing time compared to using a secondary cask. The wood pieces can be wood spires having a high surface area for chemical reaction with the spirit. The design and production of the wood pieces allow the wood to impart desired chemical constituents into the bottled cut spirit while reacting and removing other chemical constituents (e.g., undesirable chemical constituents) from the bottled cut spirit in accordance with a known volume of the bottle and time used for enhancing.

The wood pieces can also have other shapes, such as spheres, cones, cylinders, or a type of polyhedron. A non-limiting list of different type of polyhedrons that can be used include cubes, pyramids, octahedron, dodecahedron, and icosahedron. Polygons having a higher number of faces, for example an icosahedron compared to a pyramid, can have a higher surface area for chemical reaction with the cut spirit. The various shapes can also be modified such that the surface area of the wood piece is increased. For example, a face(s) or surface(s) of a wood piece can be notched, cut, scored, etc. to increase surface area that can be exposed to the cut spirit. One or more wood pieces of a first shape can be used with one or more wood pieces of a second different shape. The amount of surface area of different wood pieces can vary to provide different levels of interaction with a cut spirit. As such, a producer can control or at least influence the enhancing process and create different flavor profiles. Various combinations of different shapes and different numbers of each shape can also be used in the same bottle. For example, a spire and a sphere can placed in the same bottle. Additionally, different combinations of cutting liquids can be used with different variations of wood pieces, resting agents, and resting time.

The different type of liquids or non-liquids used for resting are collectively referred to as resting agents. One or more wood pieces can each be rested in different resting agents before being placed in the bottle. For example, a first spire can be rested in wine and a second spire can be rested in honey and both the first spire and the second spire can then be placed in the same bottle. Wood pieces of a particular shape can be rested in the same resting agent. For example, cubes can be rested in hibiscus and spheres can be rested in lavender. In some examples, the resting can produce wood pieces of different colors depending on, for example, the type of wood and the resting agent. For example, the spheres rested in lavender can have a purple color that is visible in a bottle of gin. Cutting liquids can also be used to produce a different color.

The amount of resting time can vary depending on empirical data for desired flavor profiles. At some point, absorption can be at least substantially reached where additional resting for a wood piece is not or only negligibly beneficial. The amount of resting time for the wood pieces can be six weeks and can vary depending on the type of wood piece and the resting agent.

Turning now to the figures, FIG. 1 illustrates a flow diagram of an example of a method 100 of producing an enhanced cut spirit. The enhanced cut spirit can be a finished spirit, which is a cut spirit that has been aged and then finished. The method 100 provides sealed bottles of the enhanced cut spirit that includes at least one wood piece. The method 100 uniquely delivers reproducible flavor profiles to consumers employing an in-bottle wood piece and at least one cutting liquid. Each of the steps of the method 100 can be performed by a manufacturer as part of the commercial distribution of bottled spirits. The method 100 begins in a step 105.

In a step 110, a spirit is obtained. The spirit can be a distilled spirit obtained from a producer as an already distilled product or can be produced via, for example, conventional methods. The distilled spirit can be a whisky, bourbon, rum, gin, tequila, etc. The distilled spirit can be aged. The distilled spirit can be aged by traditional methods such as placing it within wooden barrels for a designated amount of time. The amount of time can vary depending on the type of distilled spirit, different methods used (aging at sea, high altitudes, chemically controlled processes, etc.) or desired results. The spirit can be obtained as an aged distilled spirit. Additionally, the spirit obtained can be a non-distilled spirit.

In a step 115, the alcohol content of the obtained spirit is reduced or cut utilizing a cutting liquid. The resulting spirit is a cut spirit. The cutting liquid can be a non-alcoholic liquid. More than one type of cutting liquid can be used. In addition to volume, the amount of cutting liquid is based on a desired alcohol content for the cut spirit and the alcohol content of the obtained spirit. Different formulas, methods, or devices, such as a hydrometer, can be used to estimate or determine the alcohol content of the obtained spirit. The amount of cutting liquid needed to obtain a desired alcohol content for the cut liquid can also be determined by calculations and/or measurements. For example, the formula FPx+CLPy=CSDP (x+Y) can be used wherein FP is the full proof or distilled proof of the obtained spirit, CLP is the proof of cutting liquid, CSDP is the desired proof of the cut spirit, x is the volume of the obtained distilled spirit at full proof, and y is the volume of the cutting liquid used for cutting. Similar calculations based on ABV or ABW instead of proof can also be used to determine an amount of a particular cutting liquid to use.

The cut spirit is placed in bottles in a step 120. A conventional method of bottling according to the industry may be employed to place the cut spirit in bottles. As such, the bottles can be filled with the cut spirit according to industry standards. The bottles are the containers used for distributing the end product of the method 100. For example, the bottles in step 120 are the bottles that will later be sealed by the producer, distributed, and placed on shelves for purchase by the end users. Typically, the bottles are constructed of glass and have a sufficient opening to receive a wood piece as disclosed herein.

In a step 130, at least one particular type of wood piece is selected for placement in the bottles with the cut spirit. The type of wood piece selected can correspond to a particular taste profile that is desired. Several different flavor factors can be selected to obtain a particular flavor profile. The taste profiles can vary by the type of wood of the wood piece and the amount of “toast or char” to which the wood is exposed. The types of wood include, but are not limited to, American oak, French oak, Cherry, Apple, Ash, and Mesquite. The wood piece can be selected from a type of wood that has not been actually used as part of a barrel but is the type of wood that is typically used in one of the barrels for aging of a distilled spirit or a spirit, such as wine, or beer. The wood piece can also be cut from wood barrels that were previously used. The wood piece can also be cut from wood barrels that were previously used for storing non-alcoholic products or liquids, such as tea, coffee, soft drinks, etc.

Toast levels are typically used to represent the amount of toast for the wood piece and are the degrees of heat to which the wood is exposed. The heat applied to the wood or wood piece molecularly changes the wood, causing it to release certain botanicals that are inherent in the wood. In some embodiments, the different toast levels are Light toast, Medium toast, and Heavy toast. The toast levels can correspond to industry standards.

Charring is a chemical process of incomplete combustion of the wood when subjected to high heat. Char levels are the degrees to which the wood or wood piece is exposed to fire. Like toasting, charring wood causes the wood to release different botanicals and flavor essences. Different Char levels is the time or duration that the wood is exposed to fire. In one embodiment, the charring or Char levels that are used include Char 1, Char 2, and Char 3. The Char levels can correspond to industry standards.

A producer can mix and match the wood type, toast levels, and char levels to obtain different flavor profiles for the wood pieces. The producer can also use more than one wood piece and the multiple wood pieces can have a different one of one or more of a wood type, toast level, or char level. For example, one wood piece can be a medium toasted American oak with a char level of 1, and a second wood piece can be light toasted ash with a char level of 2. A combination of different shapes of wood pieces can also be used by the producer. The surface area for the one or more of the different wood pieces can also be different to allow different influences on the cut spirit from the different wood pieces. Each of the various types of wood pieces can be constructed to provide reproducible flavor profiles. For example, by employing standard toast and char levels, a producer can create and deliver reproducible flavor profiles to consumers employing in-bottle finishing. Employing a standard design, e.g., same dimensions and surface area, for the wood pieces also assists in delivering reproducible flavor profiles. For example, as noted above the wood pieces can be wood spires. To ensure the delivery of a consistent flavor profile the wood spires can be consistently cut a certain way. In some embodiments, the wood spires can be 5 inches in length (127 mm), ⅝ inches in diameter (15.875 mm), and cut in a spiral shape to expose more wood surface area. Similar construction consistency can be used for the other examples of wood pieces, also. For examples, spheres, cubes, etc. can be reproducibly constructed.

The wood pieces can be cut to provide a desired ratio of the surface area to cut spirit volume within a bottle. Considering again a wood spire as an example, the surface area to volume ratio can be 467 mm² to 750 ml. Wood spires of different dimensions can be used for different sized bottles such that there is a consistent ratio of the wood surface area to the volume of cut spirits regardless the bottle size. In some embodiments, the surface area of the wood relative to the volume of cut spirit is precisely determined to perfectly finish the cut spirit “in-bottle” within a designated amount of time. Using a 750 ml bottle, the surface area to volume ratio can be the aforementioned 467 mm to 750 ml for an in-bottle finishing of six weeks. As noted above, the desired ratio of the surface area to cut spirit volume within a bottle can vary with different wood pieces in the same bottle; this can also affect the resting of a wood piece.

In addition to the wood type, toast level, and char level, the wood pieces can also be rested to obtain specific flavor profiles. Before a wood piece is placed in the bottle of a cut spirit, depending on the taste profile that is desired, the wood piece, which can also be toasted or charred, may rest in a separate spirit, such as rum, brandy, wine or beer, to add yet another level of complexity to the final enhanced cut spirit. Instead of a spirit, the wood piece can rest in a non-alcoholic product before being place in the bottle. For example, the wood piece can be rested in one or more of coffee, tea, a soft drink, honey, syrup, or another type of non-alcoholic liquid. The wood piece can also be rested in products that are not liquids (i.e., non-liquids), such as cinnamon, nutmeg, allspice, anise, vanilla, mint, or other types of spices. Floral products can also be used, including clover, hibiscus, honeysuckle, lavender, roses, etc. Fruit products, such as apple, orange or another type of citrus, or peach, is another example of non-liquid products that can be used for resting. The non-liquid products can be mixed with water or another type of liquid to create a liquid that can be used for the resting of the wood piece. The different type of liquids or non-liquids used for resting are collectively referred to as resting agents. One or more wood pieces can each be rested in different resting agents before being placed in the bottle. For example, a first piece of wood can be rested in wine and a second piece of wood can be rested in honey and both the first piece of wood and the second piece of wood can then be placed in the same bottle. Wood pieces of a particular shape can be rested in the same resting agent. For example, cubes can be rested in hibiscus and spheres can be rested in lavender. In some examples, the resting can produce wood pieces of different colors depending on, for example, the type of wood and the resting agent. For example, the spheres rested in lavender can have a purple color that is visible in a bottle of gin.

The amount of resting time can vary depending on empirical data for desired flavor profiles. At some point, absorption can be at least substantially reached where additional resting for a wood piece is not or only negligibly beneficial. The amount of resting time for the wood pieces can be six weeks and can vary depending on the type of wood piece and the resting agent.

After selection of the wood piece, the type of selected wood piece is placed in each of the bottles by the producer in a step 140. The wood pieces can be placed in the bottles by hand. In some embodiments, multiple of a single type of the wood pieces can be placed in the bottles as long as a consistent reproducible finishing can be performed. For example, a known or desired surface area to volume ratio of wood to cut spirit can be maintained. A different type of wood piece can be placed in different bottles. For example, a French Oak wood piece can be placed in some bottles and a charred oak wood piece can be placed in other bottles. Different wood types of wood pieces can be placed in a single bottle for a mixture of finishing woods. Additionally, multiple wood pieces of the same wood type can be placed in bottles. Wood pieces of different shapes, wood types, char levels, toast level, resting agent, and any combination thereof can be placed in the same bottle. The different combinations can vary depending on the cutting liquid or cutting liquids that are used and a desired flavor profile. Thus, a particular type of wood piece can be rested in a particular resting agent and combined with a particular type of cutting liquid to obtain a desired flavor profile.

In a step 150, the bottles having the cut spirit and their one or more wood piece, are sealed. The bottles can be sealed via conventional procedures typically employed in the alcohol beverage industry. The producer seals the bottles with the one or more wood piece inside. Thus, the method 100 produces sealed bottles of a cut spirit having at least one wood piece designed/cut/manufactured for a selected flavor profile.

A label is added to the bottles in a step 160. The producer can attach labels to the bottles employing conventional methods known in the industry. Each of the labels can correspond to the cutting liquid(s) utilized and the type or types of wood pieces that is used for the enhancing. For example, a bottle can include a cut spirit of whisky and a cutting liquid of coffee, and a wood piece that is toasted American oak. Accordingly, the label can list a whiskey-coffee spirit and note a toasted oak finish from an American oak wood piece, such as a spire. The label can also indicate the type of coffee and/or brewing process of the coffee used for the cutting liquid, such as cold brew versus hot brew. When the wood piece is rested in a resting agent, the label can also note the contribution of the resting to the flavor profile noted on the label. When multiple wood pieces are in the bottle, the label can note the contribution of the combination of flavors. Thus, a consumer can know the type of in-bottle enhancing that is used with each bottle of cut spirit when purchased.

The sealed bottles of cut spirit with their at least one wood piece are then set aside in a step 170 for a designated amount of time for finishing. The amount of time can be based on empirical data and usually corresponds to the exhaustion or substantial exhaustion of the wood piece or pieces within the bottle. A wood piece is exhausted when it has imparted all or substantially all of the flavor that it can or is intended to impart to the surrounding cut spirit. Typically the designated amount of time for finishing is not changed to ensure consistent enhancing through multiple batches of production. The time for the enhancing, such as in-bottle finishing, corresponds to the completion of the exchange of chemical constituents between the wood piece and the bottled cut spirit. As such, the enhancing process, such as in-bottle finishing, disclosed herein is a function of the wood piece (design, size, production, type, toast, char, resting agent, etc.), liquid volume, and amount of time the sealed bottle is rested. The values of the variables of the enhancing process can be changed to provide the contribution of organic compounds to transform acids into esters to give the bottled spirits the desired unique flavor. In some embodiments, a taste test is used to determine a desired product taste and the combination and values of the variables used to provide the desired product taste are selected for manufacturing and consistent reproduction of the product.

Considering the wood spired discussed above as an example, once the spire is placed in-bottle, the bottle can be rested for six weeks before it is distributed or sold for consumption to allow sufficient time for the wood spire to enhance (sanctify) the cut spirit. As the finished product ages beyond six weeks, the flavor profiles typically will not change, but the product can become smoother and less harsh.

In a step 180, the bottles of cut spirit with at least one wood piece are shipped. At this point, the producer has completed the production process and the cut spirit is ready to be distributed and enjoyed by the consumer. The method 100 ends in a step 190. One skilled in the art will understand that at least some of the steps of the method 100 can be performed in a different order than disclosed herein. For example, bottles can be labeled before adding the cut spirit and/or the at least one wood piece.

FIG. 2 illustrates a flow diagram of an example of a method 200 of producing a cut spirit. The cut spirit can be a finished spirit, which is a cut spirit that has been aged and then finished. The method 200 provides sealed bottles of the cut spirit. The method 200 uniquely delivers reproducible flavor profiles to consumers employing at least one cutting liquid. Each of the steps of the method 200 can be performed by a manufacturer as part of the commercial distribution of bottled spirits. The method 200 begins in a step 205.

In a step 210, a spirit is obtained. The spirit can be a distilled spirit obtained from a producer as an already distilled product or can be produced via, for example, conventional methods. The distilled spirit can be a whisky, bourbon, rum, gin, tequila, etc. The distilled spirit can be aged. The distilled spirit can be aged by traditional methods such as placing it within wooden barrels for a designated amount of time. The amount of time can vary depending on the type of distilled spirit, different methods used (aging at sea, high altitudes, chemically controlled processes, etc.) or desired results. The distilled spirit can also be finished. The spirit can be obtained as an aged distilled spirit or a finished distilled spirit. Additionally, the spirit obtained can be a non-distilled spirit.

In a step 220, the alcohol content of the obtained spirit is reduced or cut utilizing a cutting liquid. The resulting spirit is a cut spirit. As noted above, the cutting liquid can be a non-alcoholic liquid. More than one type of cutting liquid can be used. In addition to volume, the amount of cutting liquid is based on a desired alcohol content for the cut spirit and the alcohol content of the obtained spirit. The cutting step of 220 can be performed as discussed above with respect to step 115 of FIG. 1.

The cut spirit is placed in bottles in a step 230. A conventional method of bottling according to the industry may be employed to place the cut spirit in bottles. As such, the bottles can be filled with the cut spirit according to industry standards. The bottles are the containers used for distributing the end product of the method 200. For example, the bottles in step 230 are the bottles that will later be sealed by the producer and sold to end users, such as distributed, and placed on shelves for purchase by the end users. Typically, the bottles are constructed of glass.

In step 240, the bottles having the cut spirit are sealed. The bottles can be sealed via conventional procedures typically employed in the alcohol beverage industry. Thus, the method 100 produces sealed bottles of a cut spirit that utilized a cutting liquid to create a new type of spirit.

A label is added to the bottles in a step 250. The producer can attach labels to the bottles employing conventional methods known in the industry. Each of the labels can correspond to the cutting liquid(s) utilized. For example, a bottle can include a cut spirit of whisky and a cutting liquid of coffee. The label can indicate the type of coffee and/or brewing process of the coffee used for the cutting liquid, such as cold brew versus hot brew.

In a step 260, the bottles of cut spirit are shipped. At this point, the producer has completed the production process and the cut spirit is ready to be enjoyed by the consumer. For example, the bottles of cut spirit can be distributed to stores and placed on shelves for purchase. The method 200 ends in a step 270. One skilled in the art will understand that at least some of the steps of the method 200 can be performed in a different order than disclosed herein. For example, bottles can be labeled before adding the cut spirit.

FIG. 3 illustrates an embodiment of a bottle 300 of an enhanced cut spirit. The bottle 300 includes a body 310, a lid or cap 320, a seal 330, a wood piece 340, a label 350, and a cut spirit 360 within a volume defined by the body 310. The bottle 300 is constructed of a non-permeable material. For example, the bottle 300 is made of a glass that is typically used for bottling liquor. The cut spirit 360, such as an aged distilled spirit, is an enhanced cut spirit that employs the wood piece 340 for in-bottle finishing. The bottle 300 is ready to be purchased by consumers, such as being placed on shelves for purchase or ordered via a website. The bottle 300 is an example of a bottle produced by the method 100.

The body 310 defines the shape and volume of the bottle 300. The body 310 has an inner and outer surface. The body 310 is collectively representing the base, heel, shoulder, etc., and other known parts of a bottle. Bottles having bodies of other shapes can also be used.

The lid 320 is used to cover the orifice of the bottle 300. The lid 320 can be cork, a screw cap, or another type of lid that is conventionally used.

The seal 330 is used to secure the lid 320 and indicate no tampering from the producer to the consumer. Conventional types of seals can be used and the illustrated seal 330 is an example of one type that can be used. As illustrated, the bottle 300 is capped and sealed after the wood piece 340 is placed in the bottle 300. Since the bottle 300 is for commercial sale, the seal 330 is unbroken.

The wood piece 340 is placed in the bottle 300 before the lid 320 and the seal 330 are placed thereon. The wood piece 340 can be a spire as illustrated or have another configuration, such as a cylinder, a cuboid, or another 3D shape. As disclosed herein, the wood piece 340 can be designed to correspond to the volume of the bottle 300 and a desired finishing time. When first placed in the bottle 300 with the enhanced cut spirit 360, the wood piece 340 will float. The wood piece 340 absorbs the enhanced cut spirit 360 during the process of exchanging chemical constituents with the enhanced cut spirit 360 and sinks to the bottom of the bottle 300. In FIG. 3, the wood piece 340 is saturated with the enhanced cut spirit 360 and has sunk to the base of the bottle 300.

The label 350 can indicate the distinct type of alcoholic product within the bottle 300, which is created by the combination of the cutting liquid with a distilled spirit, and the components and information of the components that make-up of the new product. For example, the spirit, the alcoholic content of the spirit, the type of cutting liquid, the amount of cutting liquid, and the alcoholic content of the cutting liquid if applicable can also be included on the label 350. The label 350 can also include information about the wood piece 340 within the bottle 300. The label 350 can be attached to the bottle 300 via a conventional procedure. The body 310 can include an indentation area (not identified in FIG. 3) that corresponds to a shape and size of the label 350 and the label 350 can be placed within the indentation section. The bottle 300 with lid 320, seal 330, wood piece 340, label 350 and enhanced cut spirit 360, can be shipped for commercial distribution and sale.

As noted herein, the wood piece 340 can be rested in a resting agent, such as another liquid, before being placed in the bottle 300. The resting agent can be a spirit that is different than the enhanced cut spirit 360 or a non-alcoholic liquid. The resting agent can also be different than the cutting liquid used with the cutting liquid. When the wood piece is rested, the label 350 reflects the contribution of the resting to the flavor profile of the enhanced cut spirit 360. The wood piece can be infusion spirals commercially available from, for example, The Barrel Mill in Central Minnesota.

FIG. 4 illustrates an example of a bottle 400 of a cut spirit 440 produced according to the principles of the disclosure. The bottle 400 includes a body 410, a lid or cap 420, a seal 430, and a label 450. The cut spirit 440 is within a volume defined by the body 410. The cut spirit 440 can correspond to similar items described herein. For example, the cut spirit 440 can be aged and/or finished. The spirit may have been aged and/or finished before being cut or may have been aged and/or finished after cutting and before bottling. The bottle 400 is ready to be sold, either wholesale or retail. The bottle 400 is an example of a bottle produced by the method 200.

The bottle 400, lid 420, seal 430, can correspond to similar items disclosed herein. Accordingly, as with the body 310 of bottle 300, the body 410 defines the shape and volume of the bottle 400. The body 410 is collectively representing the base, heel, shoulder, etc., and other known parts of a bottle. Bottles having bodies of other shapes can also be used. The lid 420 is used to cover the orifice of the bottle 400. The lid 420 can be cork, a screw cap, or another type of lid that is conventionally used in the industry. The seal 430 is used to secure the lid 420 and indicate no tampering from the producer to the consumer. Conventional types of seals can be used and the illustrated seal 430 is an example of one type that can be used. Since the bottle 400 is produced to be sold, the seal 430 is unbroken.

The label 450 can indicate the distinct type of alcoholic product, the cut spirit 440, which is created by the combination of the cutting liquid with the spirit, and the components and information of the components that make-up of the new product. For example, the spirit, the alcoholic content of the spirit, the type of cutting liquid, the amount of cutting liquid, and the alcoholic content of the cutting liquid if applicable can also be included on the label 450. The label 450 can be attached to the bottle 400 via a conventional procedure. The bottle 400 with lid 420, seal 430, label 450 and cut spirit 440, can be shipped for commercial distribution and sale.

FIG. 5 illustrates an example of a bottle 500 of a cut spirit 540 having wood pieces for enhancing. The bottle 500 includes a body 510, a lid or cap 520, a seal 530, a cut spirit 540, a label 550 and wood pieces 560. The cut spirit 540 and the wood pieces 560 are within a volume defined by the body 510. The cut spirit 540 can be aged and/or finished in addition to the in-bottle finishing by the wood pieces 560. The spirit of the cut spirit 540 may have been aged and/or finished before being cut or may have been aged and/or finished after cutting and before bottling.

The bottle 500 is constructed of a non-permeable material, such as glass, and is ready to be sold. For example, the bottle 500 is ready to be distributed and placed on shelves for purchase by consumers. The body 510 defines the shape and volume of the bottle 500. The body 510 collectively represents the base, heel, shoulder, etc., and other known parts of a bottle. The lid 520 is used to cover the orifice of the bottle 500 and can be cork, a screw cap, or another type of lid that is conventionally used. The seal 530 is used to secure the lid 520 and indicate no tampering from the producer to the consumer. Conventional types of seals can be used. As illustrated, the bottle 500 is capped and sealed after the wood pieces 560 are placed in the bottle 500. Since the bottle 500 is for sale, the seal 530 is unbroken in FIG. 5.

The wood pieces 560 are placed in the bottle 500 before the lid 520 and the seal 530 are placed thereon. The wood pieces 560 include a pyramid 562, a cube 563, and spheres 565, 567, and 569. One of more of the wood pieces 560 can be different types of woods, with different toast levels, char levels, or neither no toast nor char. The surface area of one or more of the wood pieces 560 can also be different. One or more of the wood pieces 560 can also be rested wood pieces that have rested in a resting agent or agents before being placed in the bottle 500. A combination of the wood pieces 560 rested in different resting agents can be used. For example, the pyramid 561 can be rested in a first resting agent and the cube 563 can be rested in different resting agent. One or more of the spheres 565, 567, 569, can be rested in one of the same resting agents or yet in a third resting agent. Each of the spheres 565, 567, 569, can be rested in the same resting agent. The different wood pieces 560 can inherent a color from their resting agent that can provide a pleasing visual presentation in the bottle 500 along with the functional enhancing of the cut spirit 540. The wood pieces 560 can have other shapes than those shown in FIG. 5 and the number of wood pieces can vary. As disclosed herein, the wood pieces 560 can be designed to correspond to the volume of the bottle 500 and a desired time for enhancing the spirit. When first placed in the bottle 500 with the cut spirit 540, the wood pieces 560 will float. The wood pieces 560 absorb the cut spirit 540 during the process of exchanging chemical constituents with the cut spirit 540 and sink to the bottom of the bottle 500. In FIG. 5, the wood pieces 560 are saturated with the cut spirit 540 and have sunk to the base of the bottle 500.

The label 550 can include information such as included with label 350 and/or 450 of FIGS. 3 and 4. For example, the label 550 can include the type of wood pieces 560 within the bottle 500 and also include the cutting liquid or liquids used. The label 550 can be attached to the bottle 500 via a conventional procedure. The bottle 500 with lid 520, seal 530, cut spirit 540, label 550 and wood pieces 560, can be shipped for commercial distribution and sale. The cut spirit 540 is an enhanced cut spirit. When one or more of the wood pieces are rested, the label 550 reflects the contribution of the resting to the flavor profile.

Those skilled in the art to which this application relates will appreciate that other and further additions, deletions, substitutions and modifications may be made to the described embodiments. For example, in-bottle aging using a wood piece for commercial sale for spirits, including spirits that are not distilled, may also be used; different aging times and wood to volume ratio may be required. This disclosure can also apply to imparting a flavor from a wood piece or another type of flavor provider in a bottle, of other types of liquids, that is produced for commercial sale as provided herein. Different types of cutting liquids can also be used and can be combined. A cut spirit can also be bottled without a wood piece, such as according to method 200 and bottle 400.

1. A method of producing a cut spirit, comprising:
obtaining a distilled spirit; and
reducing alcohol content of the distilled spirit using a cutting liquid to create a cut spirit.

2. The method as recited in claim 1, further comprising placing the cut spirit in a bottle and sealing the bottle.

3. The method as recited in claim 2, further comprising attaching a label on the bottle, wherein the label indicates the cutting liquid.

4. The method as recited in claim 3, wherein the obtaining, the reducing, the placing, the sealing, and the attaching are performed for multiple bottles by a manufacturer.

5. The method as recited in claim 1, wherein the distilled spirit is cut using the cutting liquid instead of using water.

6. The method as recited in claim 1, wherein the cutting liquid is a non-alcoholic liquid.

7. The method as recited in claim 6, wherein the cutting liquid is coffee.

8. The method as recited in claim 6, wherein the cutting liquid is a juice.

9. The method as recited in claim 1, wherein the cutting liquid includes a spirit.

10. The method as recited in claim 9, wherein the spirit is wine.

11. The method as recited in claim 1, wherein the cutting liquid is used to obtain a desired alcohol content of the cut spirit.

12. The method as recited in claim 11, wherein an amount of cutting liquid used for the reducing is determined by FPx+CLPy=CSDP (x+Y), wherein FP is a distilled proof of the obtained spirit, CLP is a proof of the cutting liquid, CSDP is a desired proof of the cut spirit, x is a volume of the obtained spirit at full proof, and y is a volume of the cutting liquid used for cutting.

13. The method as recited in claim 1, wherein the reducing the alcohol content of the distilled spirit includes using more than one cutting liquid.

14. The method as recited in claim 1, wherein the obtained distilled spirit is uncut.

15. The method as recited in claim 1, wherein the obtained distilled spirit is an aged, distilled spirit.

16. The method as recited in claim 1, further comprising placing the cut spirit in a bottle, placing a wood piece in the bottle, and sealing the bottle having located within both the cut spirit and the wood piece, wherein the wood piece has been rested in a resting agent before being placed in the bottle.

17. A method of manufacturing an alcoholic beverage, comprising:
obtaining a distilled spirit;
creating a cut spirit by reducing alcohol content of the distilled spirit using one or more cutting liquids;
placing the cut spirit in multiple bottles; and
sealing the multiple bottles.

18. The method as recited in claim 17, wherein the one or more cutting liquids include a non-alcoholic liquid.

19. The method as recited in claim 17, wherein the creating the cut spirit includes obtaining a desired alcohol content of the cut spirit using the one or more cutting liquids.

20. The method as recited in claim 17, wherein the distilled spirit is whiskey or bourbon and the one or more cutting liquids includes coffee.
